(19) United States
(12) Patent Application Publication
(10) Pub. No.: US 2009/0228478 A1
(43) Pub. Date: Sep. 10, 2009

(54) System and method for organizing and evaluating different points of view on controversial topics

(76) Inventor: Terril John Steichen, Fairfax, VA (US)

Correspondence Address: Terril J. Steichen, 9814 McLearen Court, Fairfax, VA, 22030, US

(21) Appl. No.: 12/380,609

(22) Filed: Mar. 2, 2009

Related U.S. Application Data
(60) Provisional application No. 61/068,379, filed on Mar. 6, 2008.

(51) Int. Cl. G06F 17/30

(52) U.S. Cl. 707/5; 707/102; 707/E17.014; 707/E17.044

(57) ABSTRACT

A system and method for organizing and evaluating different points of view on controversial topics that minimizes the ‘spin’ that typically accompanies different opinions, and also minimizes the tendency to ‘cherry pick’ issues by emphasizing only those that support a particular point of view and ignoring others. It allows these different points of view to be compared side by side, and computes the similarity between them.

### CROSS-REFERENCE TO RELATED APPLICATIONS

This application claims the benefit of provisional patent applications Ser. No. 61/068,379, filed 2008 Mar. 6.

### BACKGROUND OF THE INVENTION

1. Field of the Invention

The present invention generally relates to the field of organizing and evaluating differing points of view using computerized techniques.

2. Prior Art

The public is inundated with claims and counter-claims about every imaginable issue. Every time we turn around it seems we are confronted with a new controversy of some sort, accompanied by all sorts of conflicting claims. Each claim comes to us wrapped in spin, including cherry-picked facts that support it, and excluding those that don't. Sometimes facts seem to simply get invented when convenient.

In such an environment, it's hard to keep things straight. It's hard enough to keep track of our own personal thinking on matters that interest us, let alone all that of the many interests competing for our attention. The temptation is sometimes strong to simply shut ourselves off from the world for a while to try to let things settle down. Or, we just give up and agree to endorse some position, which often turns out to be the opposite of the position our neighbor gave in to. And we end up totally polarized.

This kind of polarization has made it look like the whole country is clustered at one end or the other of an perspective spectrum, with few people found in between. But extensive research over the past 25 years that suggests the reality is just about the opposite: there are a relatively few activists at each end, but most people are in the middle someplace.

The problem is that the activists have gotten the publicity and they have more or less succeeded in appearing to ‘own’ the slogan that signifies their side. Positions in between the extremes don't seem to have any legitimacy because most non-activists don't have a ready handle or name or slogan that applies to what they really believe themselves.

In recent years, a number of online systems have emerged that attempt to organize different points of view on the broad range of topics that the typical person confronts. They have used a number of different kinds of conventional web-based publishing software, including ordinary websites, blogs and discussion forums, and wikis.

The standard website is, from the users' perspective, ‘read-only’. All the content is put out by the publisher; users don't directly participate in generating any of the content. This approach is useful only in declaring positions, not in resolving them.

In contrast, software designed on the ‘blog’ model allows users to participate by contributing perspectives about a topic posted by the blog owner. These comments are additive, meaning that new thoughts are captured by additional comments, not by changes to the original ones. Also, the content within the comments is often quite different or even opposed to each other. To get an overview of the participant's views, however, a user has to read the whole set of comments, which can be a very torturous process.

Software designed to use the ‘wiki’ model allows every user to contribute by adding and changing the same basic set of content. The most well-known application is Wikipedia, which uses the wiki software model to develop and maintain a massive online encyclopedia. The ‘wiki’ model allows a viewer to see a composite of all participants' contributions in one concentrated area. However, the wiki's effectiveness in generating meaning content breaks down when the participants don't agree with each other.

Yet, despite its robust nature, Wikipedia is largely unable to handle conflict, particularly when pertaining to topics that are quite controversial. Moreover, because Wikipedia seeks to describe everything relevant about some topic, the controversies inherent in a topic become only a minor part of the overall content.

However, Wikipedia offers no substantial structure to its content. Specifically, Wikipedia offers no capability to display a set of issues and related viewpoints on the issues, and no way to display different points of view (or perspectives) in a way that reflects specific viewpoints on specific issues.

Debatepedia was developed specifically to introduce some structure for controversial issues. However, it uses the same underlying (wiki) software as Wikipedia, and though it does provide the capability of listing issues and viewpoints on the issues, Debatepedia provides no means to handle points of view on these issues. Moreover, the viewpoint options are limited to two: pro-con, or yes-no; yet there are many issues that require more alternative viewpoints to reflect the full range of views. Because it allows users to create topics (aka, debate pages), Debatepedia's structure reflects large overlaps of issues (aka subquestions).

ProCon.org has also focused on introducing a more structured way to organize issue-related content. Yet it too fails to offer a means for maintaining multiple different points of view, let alone the capability to compare them. Significantly, the ProCon.org content is generated and controlled by the central staff, either directly or via experts managed by that staff. And here too, the viewpoints are limited to a simple pro-con dichotomy.

Several other offerings have also attempted to address the challenges of organizing different points of view. Some of these are OnTheIssues.org, WhereIStand.com, ChainsOfReason.org, OpposingViews.com, PublicAgenda.org, LittleSis.org, WhoRunsGov.com, SpeakOut.com, YouDebate.com, and E-Democracy.org, to list the more prominent ones. However, these share the same shortcomings as do Wikipedia, Datapedia and ProCon.org.

What's needed is a system that will allow complex points of view by key players on today's topics to be captured, organized, analyzed and compared. That is what the instant invention, hereinafter referred to as “TopicCentral”, provides.

### OBJECTS AND ADVANTAGES

Accordingly, several objects and advantages of the invention are:
1. supports multiple types of perspective profiles
   public figures and groups
   concepts, causes and philosophies
   proposed and existing policies
   personal opinions and beliefs
2. supports distributed provision of content
   no reliance on outside “experts”
   because crowd-sourced, no need for significant funding (creating its own conflicts of interest)

3. distributes control over the content (other than the top-level structure) with no moderating of issue or profile content
4. issue-related content is completely independent from profile-related content
   controversies and points of view kept separate
5. issue-related content is collaboratively created/maintained
6. issue-related content is organized by structure (rather than free-form)
   allows for a small number of simple and objective rules
   allows for minimizing reading burden
   allows for cross-referencing
7. profile content is largely defined by pick lists of viewpoints, not new rhetoric, leaving no place for users to inject “spin” and other distortions
8. profile content is created and controlled by individual users with unique profile names, enabling a high degree of accountability.
9. offers a very comprehensive sets of issues, with anti-cherry picking features for referencing profiles, resulting in more complete and meaningful profiles
10. creates strong incentives for content contribution, especially by sponsors in creating perspective profiles and filling in any missing issues
11. minimizes conflict between parties with opposing points of view
   no limit on different viewpoints
   separation of issue and viewpoint
   separation of viewpoint and arguments
   arguments are supporting only
      argument differences can be channeled into creation of new issues
   item removal is moderated, with disincentives for overuse
12. provides for direct and precise comparison of profiles
   similarity scoring of profiles
   side-by-side profile comparison
13. viewpoints are not constrained to be pro-con
   parent issues stated as questions not propositions
   no limit on number or nature of viewpoints
   viewpoints separated from arguments

### BRIEF SUMMARY OF THE INVENTION

The main purpose of the instant invention, hereinafter referred to as TopicCentral, is to help users understand and compare the positions (represented by ‘perspective profiles’) held by various players on key topics. Thus the main focus is less on issues themselves, but rather on which parties support what views on the issues.

TopicCentral's internal architecture is unique in that it maintains the issue-related content distinctly separate from that of the perspective profiles. And, while the issues are completely independent from the profiles, the profiles directly reference (and thus depend on) the issues.

TopicCentral takes all of the key current topics of controversy, identifies the main opposing perspectives for each, and then lays these perspectives out in a unique form that's easy to understand, and that lets the different perspectives be directly and objectively compared with each other.

The direct influence of TopicCentral itself on the content quantity and quality is minimal. Except for the definition of the top-level structure, all TopicCentral content is the product of its users. The issue-related content is created and maintained collaboratively by all TopicCentral users, though the users' creation and editing activities operate within a distinctive structure. That is, the issue-related content is not free-form, except within specific structural elements.

To facilitate a high level of user participation, TopicCentral includes a wide range of innovative techniques to extract value from—but not squelch—disputes and differences of perspective.

In contrast to the collaborative production of the issue-related content, each TopicCentral perspective profile is created and maintained by an individual user (the one who created the profile). However, the content of a profile is constrained by the issue content. The profile owner is free to make choices, but the options from which to choose are defined by the collaboratively managed issue content.

Because of this architecture, the similarity of perspective profiles may be computed, and each profile, regardless of its type, may be directly compared with other profiles.

The software implementing TopicCentral is highly customized, incorporating elements of both the blog and wiki model, as well as unique new elements. There are two kinds of content repositories within TopicCentral: (1) the collection of perspective profiles, and (2) the collection of issue-related content.

New perspective profiles, like blog comments, are additive. Each user can provide their own set of profiles, and no other user can change them. However, unlike a blog comment, each perspective profile can be (and usually is) readily hanged by its owner. Also, while a blog is pretty much form-free, the perspective profile follows a carefully designed structure. A TopicCentral user may choose the name of any perspective profile they create, provided that name isn't already associated with another perspective profile. And, while they can associate any existing viewpoint with that profile, they must choose those viewpoints from the existing set.

The second TopicCentral content repository contains a set of issues, organized by topic, accompanied by associated issues, viewpoints and arguments. This repository is developed and maintained in a manner that shares some characteristics with the wiki. However, this content is also governed by a hierarchical structure (a characteristic very different from an ordinary wiki).

### BRIEF DESCRIPTION OF DRAWINGS

FIG. 1 shows the overall structure of the instant invention.

FIG. 2 depicts the hierarchical structure of the topics, issues, viewpoints and arguments.

FIG. 3 further describes the hierarchical structure of topics, issues, viewpoints and arguments.

FIG. 4 describes the main features of the perspective profile.

FIG. 5 describes an illustrative example of how the hierarchical structure is populated with actual content.

FIG. 6 depicts the relationship between the item-related content and the perspective profile content.

FIG. 7 shows the main functions supported by the instant invention and their relationship to each other.

FIG. 8 depicts more detail on the polling-related tasks.

### DETAILED DESCRIPTION OF THE INVENTION

The present invention, hereinafter referred to as “TopicCentral,” is an online computer system providing users with a unique perspective on prominent positions or points of view on a wide range of topics. These perspectives are behind the efforts of special interest groups and other advocates to garner more public support for their points of view.

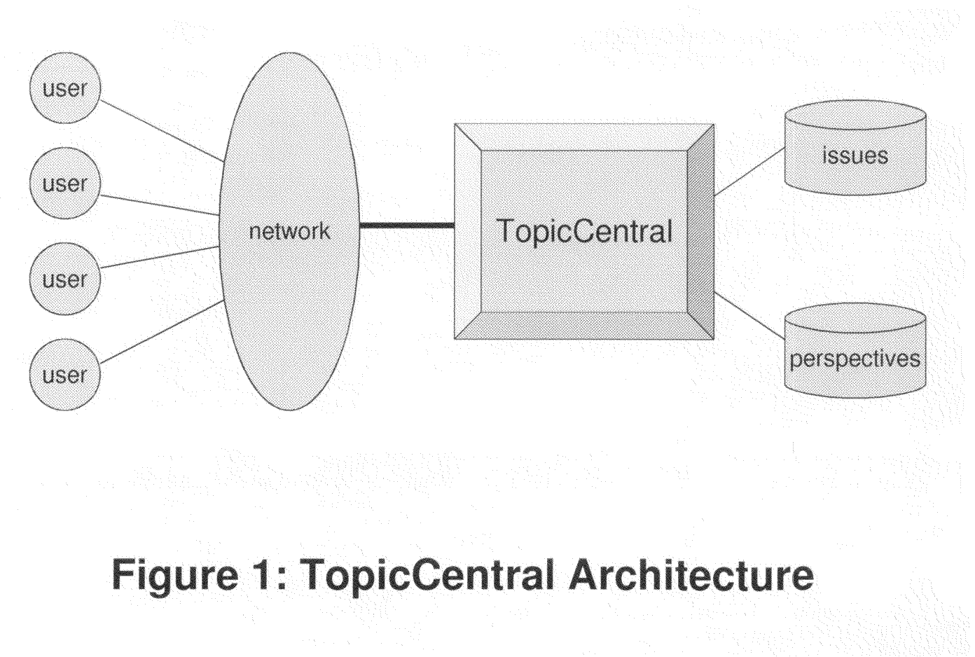

As shown in FIG. 1, the preferred embodiment of the invention is implemented through an network-connected server connected to multiple clients. Naturally, the server function could be spread over several machines for load-sharing and reliability.

The main components of the preferred embodiment are the central logic, the issue-based content manager and the perspective-based content manager.

The central logic is implemented as a set of Java Server Pages that have been integrated with an existing JSP-based framework (open source JSPWiki). Naturally, there are a near-infinite number of other possible sources of implementation logic.

Technically, TopicCentral is implemented by customizing an open source wiki software system called JSPWiki. As the name suggests, the JSPWiki system is based heavily on the use of Java Server Page or JSP modules. Most of the TopicCentral functionality is produced by branching off into a set of about 20 additional JSP modules, along with relatively minor changes to a dozen or so JSPWiki modules. TopicCentral allows visitors not logged in to view much of the content, but restricts the ability to add new content and edit existing content, to users who are logged in. Moreover, some elements and tasks (topics, administrative functions, etc.) are restricted to users who have been granted administrative rights.

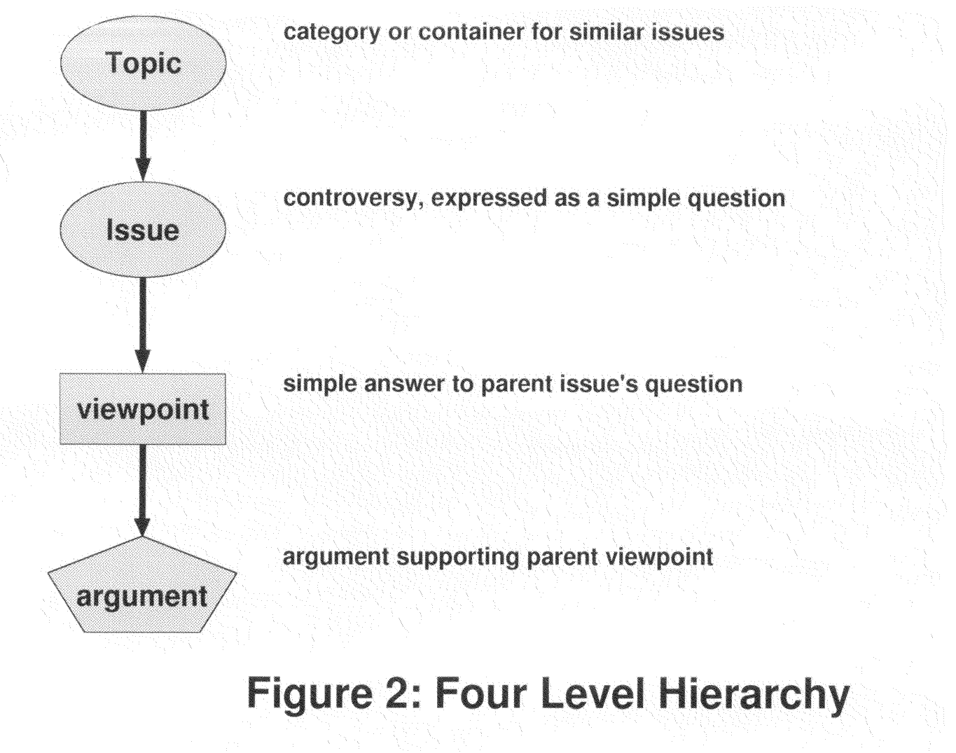

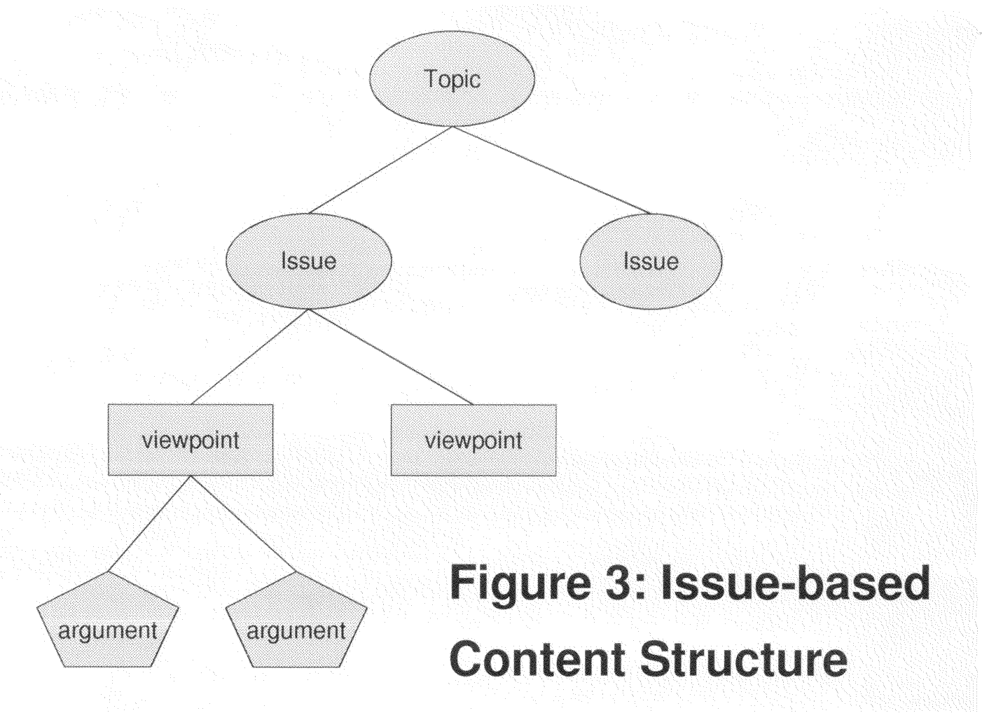

The preferred embodiment maintains two main content collections. The structure of the issue-related content collection is shown in FIGS. 2 and 3. The issue-related content follows a hierarchical structure starting with a collection of top-level topics. Each topic has a set of ‘child’ issues, which in turn has a set of ‘child’ viewpoints, each containing a set of ‘child’ arguments. Each element (issue, viewpoint, argument) knows not only what item is it's ‘parent’ but which topic family it belongs to.

Each element has a set of text components, each representing either the current or a previous version of the text. The topic element also contains a summary item.

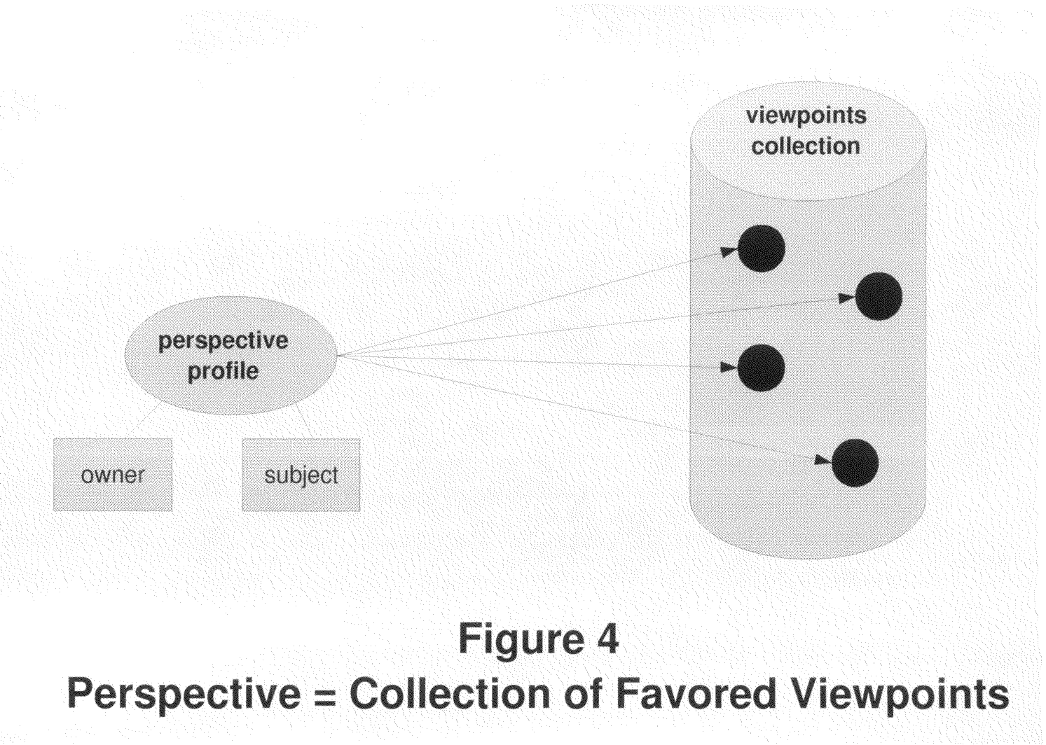

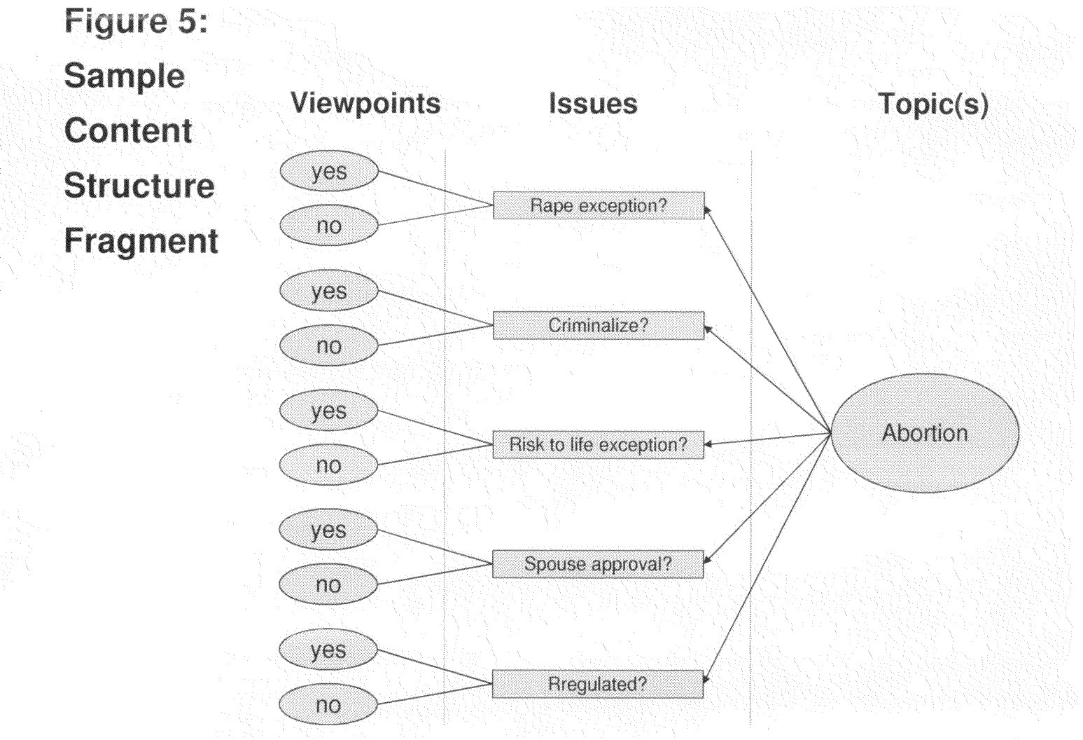

The perspective-related content collection is shown in FIG. 4. (A specific example using the ‘abortion’ topic is shown in FIG. 5.) It is comprised of a collection of ‘perspective profiles’. Each such perspective profile has a number of associated characteristics, including name, owner, type and certification. Each perspective profile also contains a set of references to viewpoints (included in the issue-related content collection). Each viewpoint reference points to a viewpoint that is presumed to be favored by advocates of the perspective represented by the perspective profile.

The ‘name’ (also called ‘subject’) characteristic of an perspective profile represents the associated perspective, which might also be described as a cause, movement, group, philosophy, policy, as well as a public person (such as a politician) or a private individual.

Each viewpoint reference within an perspective profile may optionally be associated with a note and a strength (of association) along with a date/time of when the reference was defined.

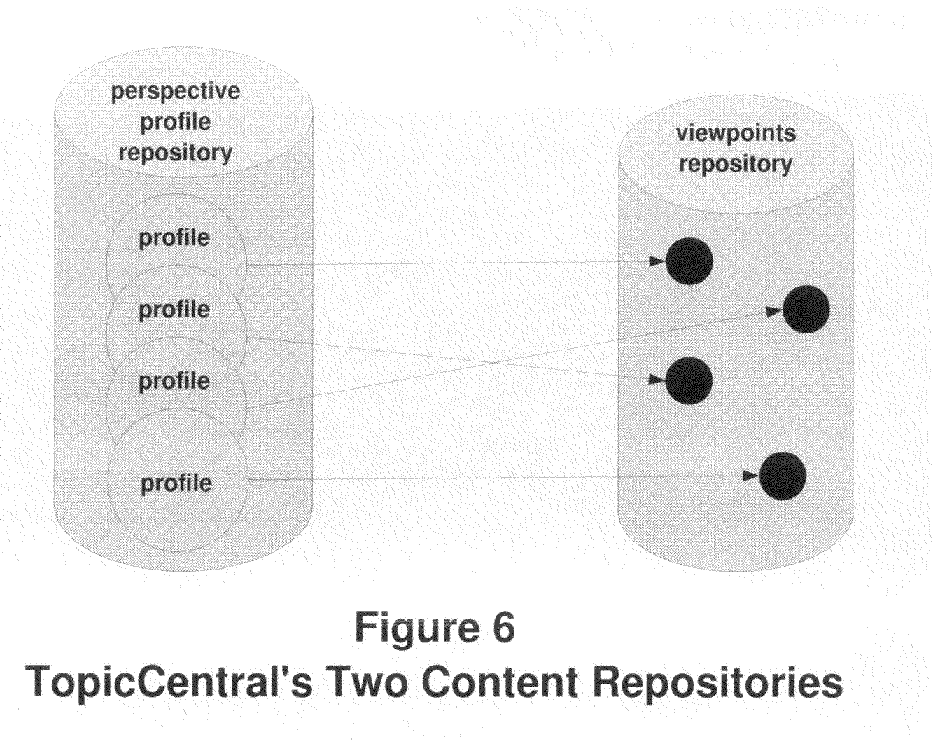

As shown in FIG. 6, two different profiles can be compared with each other because they all reference a common set of viewpoints. This comparison makes it easy to identify not only the viewpoints held in common by the subject of the perspective profiles being compared, but also to identify the areas of difference. It is often the case that many of the differences do not reflect any outright clash, but rather a slightly different preference for some issue outcomes.

Users can create new and modify existing issues. Advocates of a particular viewpoint regarding an issue can promote their outlook by adding issues that highlight the most appealing aspect of what they advocate, and by adding issues that bring out the most extreme (and presumably unappealing) aspects of the viewpoint that opposes the one they favor.

For a given issue, there's not too much that an advocate can do to distort the content in their favor (other than not adding viewpoints that they don't favor—but these will be added by advocates that favor those (missing) viewpoints.

Advocates of a particular viewpoint can add as much rationale as they choose in the form of supporting arguments. They can also seek to undercut arguments supporting viewpoints they oppose by challenging any factual weaknesses in those arguments

The perspective profile cannot be edited by users other than the profile's owner. Advocates of a particular perspective will generally find it in their interest to be the first to create an perspective profile with the label they prefer to be associated with their outlook. This is because once an perspective profile has been created with a given label, that label (name) cannot be used for another perspective profile.

For each topic, the figure of merit is whether all the relevant issues are included, and for each of those, is the full range of viewpoints and arguments included as well. TopicCentral is structured so that the conflicting motivations of advocates (and their opponents) will produce the fullest possible range of issues, viewpoints and arguments.

For the perspective profiles, the figure of merit is not only whether an perspective is represented, but also whether it represents an accurate portrayal of the perspective associated with it. For the set of perspective profiles, the full range of prominent perspectives will be fleshed out by the combination of ordinary users who are confronted with advocates of various perspectives, and the advocates (and their opponents) themselves.

Under TopicCentral, a given issue may have more than two different viewpoints. In these situations a simple ‘pro-con’ differentiation is inadequate. Moreover, even if the individual issues under a topic happen to have only two viewpoints each, a ‘pro-con’ demarcation at the topic level often makes no sense. For example, trying to differentiate a population into advocates (‘pro-abortion’) and opponents (‘con-abortion’) fails to reflect the true level of complexity actually present. While there certainly might be some that might be comfortable labeling themselves as ‘con-abortion’ (by implication, in any way, shape or form, under any and all circumstances), there may be few if any who consider the ‘pro-abortion’ label accurate. And there are many, many others who have views about abortion that are not properly described by either label.

### Perspective Profiles

The central distinguishing feature of the invention is the ‘perspective profile’, which corresponds to a particular perspective or point of view, and which contains a set of references to specific viewpoints on specific controversies related to some topic or topics. Inclusion of a referenced viewpoint in an perspective profile indicates that advocates of the associated perspective favor that viewpoint.

TopicCentral ensures that the profile names are unique and allows only the profile's owner (or the admin) to change a profile's characteristics. These perspective profile characteristics include (a) a name, (b) a set of references that identify favored viewpoints, (c) the owner's identity, (d) a visibility flag, and optionally, (e) a certification.

A profile's owner can change owned profiles in a number of ways: (1) rename, (2) delete, (3) toggle visibility, and (4) change the set of viewpoint references. The owner can do the latter (change the references) by either (a) adding or removing individual references, (b) changing some/all references to viewpoints under a specific topic, or (c) by importing the contents of another existing profile.

A profile owner can request that a profile be certified as authoritatively reflecting the position of an organization. After verifying that bona fides of the requesting user, an indication of certification will be displayed alongside that profile to other users (presuming the profile has been made public). Only an admin can make, change or remove such a certification. The owner cannot directly delete a certified profile.

A TopicCentral admin may enter information about certain groups that are closely associated with a specific perspective profile. That association may be assumed, or it may be certified.

Perspective profiles may be assigned a type by the owner: concept, group, personal, public. The owner can also optionally associate some additional information to each and every referenced viewpoint, including (1) the perceived strength of the support exhibited by the parent perspective profile for that particular viewpoint, and (2) a note (such as who provided the information backing that relationship, etc.).

A viewpoint reference within an perspective profile contains a pointer to the viewpoint instance, including its version. If subsequently that viewpoint is modified, the next time the profile contents are displayed to the owner, a flag will indicate the occurrence of that change, providing the owner with the opportunity to change the reference if appropriate.

Users may also view a comparison of two or more perspective profiles in a manner that highlights the viewpoints the compared profiles reference in common, and those in which they differ.

### Issue-Related Content

The viewpoints being referenced by an perspective profile are contained in a repository of issue-related content that reflects a hierarchical structure (topic->issue->viewpoint->argument). Any user can create new mutable items: issues, viewpoints and/or arguments. Topic items, however, are immutable, created, edited and removed only by admins. To create a mutable item, the user must choose the specific mutable item type (issue, viewpoint or argument) prior to entering the content.

Any user can send a message to the most recent creator/editor of a mutable item, such as requesting a change or asking for additional rationale. Any user can edit an existing mutable item. Any user can revert any mutable item to reflect an earlier version.

Any user can challenge any mutable item, causing a nominal review by a mediator; the mediator may optionally remove the challenged item. Between the time of the challenge and the time of the mediator resolution of the challenge, the challenged item is marked with a flag visible to all users indicating that it is currently under challenge. While under challenge, the item can't be edited any further. The mediator may optionally decide that the views of the challenged author and the challenger have equal merit and decide to place a flag to indicate that the item is in dispute, but allow further edits. The admin may also lock an item, which prevents editing and which causes a flag to be displayed to all users indicating the item's locked status.

TopicCentral imposes a set of manually-enforced rules, some of which apply only to specific mutable types while others apply to all mutable types. Rules that apply to specific mutable item types include:
Issues must be expressed as a simple, validly formed question. Invalid questions include questions that:
   imply only one possible viewpoint, such as “Is it likely that the sun will rise tomorrow?”, or that,
   logically exclude a key viewpoint, such as “When did you stop beating your wife?”
Viewpoints must be expressed as simple answers to the parent question, and be devoid of argument.
Arguments must be expressed as supporting rationale for the parent viewpoint, and must be supportable by reliable, factual sources.

General rules that apply to all mutable items types include:
minimize duplication among sibling items
relevant to parent items

If an item is changed, child items to that which was changed will have a flag that indicates the change occurred and urges the viewer to verify that the changed parent doesn't require changes to the child. Clicking on the flag provides this validation.

TopicCentral users may view the issue-related content directly, optionally filtered to show only issues, issues and viewpoints or all items. Users may also view the content in conjunction with an perspective profile filter, in which case the selected viewpoints will be highlighted.

The repository of issue-related items is managed in a wiki-like manner, with users able to create and change content. However, it differs from a typical wiki in several important ways:
it is based on a hierarchical structure (rather than a flat set of pages)
items in the topic-level of that structure are immutable.
prior to creating a new item, users must select the item type
many of the rules are item-specific
no direct deletion—the challenge mechanism provides indirect deletion

The aspects of TopicCentral that pertain to the perspective profile, contain references to reference viewpoints within the issue-related repository. However, the references themselves are separate from the viewpoints and reside outside the issue-related repository.

TopicCentral optionally allows issues to be grouped by categories. The categories themselves are defined by an admin, who may edit or delete them as well. However, any user can make or change an assignment of an issue to a category. [It should be understood that the role of an ‘admin’ in the inventive system is not restricted to users with full rights to do everything. Certain groups of trusted users may be assigned different levels of admin rights.]

TopicCentral provides different operational modes dealing with the content. The edit mode allows users to ‘drill-down’ into the content hierarchy, adding and changing items as desired. For each mutable item, the user has the option to (a) change the content of the item, (b) review previous versions and revert to one of these previous version, (c) comment on the item, which is automatically routed to the latest author of that content item, (d) discuss the item, which is automatically routed to s forum created on that item, (e) challenge the item, or (f) create a new child item.

The profile mode displays all the content items pertaining to the selected topic, along with the option to select an perspective profile. When the perspective profile is selected, the displayed viewpoints corresponding to those referenced in the perspective profile will be highlighted. If the user selecting this profile also happens to be the profile's owner, options are displayed that allows the user to change individual selections and save the changes. Users also have an option to display only the viewpoints corresponding to the selected profile (rather than also showing the unselected ones).

A topic search option is provided, allowing users to conduct keyword searches. The index is generated by aggregating information from various items by topic. That is, the contents of all of a topic's issues, viewpoints and arguments are referenced in the index. Moreover, the index generates a wide range of fields, including topic_code, topic_title, type, num_issues, num_viewpoints, num_arguments, tokens (default), and summary info. Admins have access to all of these fields which are used to determine which topics are ready for full use and which are in various stages of development.

TopicCentral provides dynamically-generated lists of topics, using some of these criteria. For example, using the above criteria, a user may identify the most mature topics and put them in one list, and a list of less mature topics in another, and a list of topics that need lots of work in another. It is possible to restrict access to these lists based on some user criteria.

### TopicCentral Statistics

A large number of statistics are kept track of by TopicCentral and made available to its users (some are only available to admins). These include:
personal
   items I've recently changed
   others changes to my changes
   others uses of profiles owned by me
   my recent visits
   my cumulative online time
content
   most popular
   most frequently viewed
   most recently viewed
   most frequently changed
   most recently changed
profiles
   most popular
   most frequently viewed
   most recently viewed
   most frequently changed
   most recently changed
   most viewpoint references
users
   currently logged in users
   most online time
   most site visits
   most recent site visits
   most public profiles owned
   most active
   most participating
   most recently active

In the event that a user modifies a mutable item, a message is automatically sent to the previous author of that item, describing the latest change.

### Miscellaneous Aspects

TopicCentral is operated on an invitation-only basis. An authorized user (or admin) can create an invitation code. A visitor possessing that invitation code may cause an user account to be created for them; the password for that account will be automatically e-mailed to them by TopicCentral. The invitation code has a number of optional characteristics: (a) it may or may not allow the recipient to create new, derivative invitation codes, (b) it may contain an expiration interval, and (c) a limit on the maximum number of invitees.

Users can automatically monitor changes in any and all topics using RSS (Really Simple Sundication, a broad standard). Once a topic monitor has been established, all changes or additions of any item under that topic will be automatically reported. In addition, when a change is made to an existing item, the last editor will automatically be notified of the change. Admins can also monitor a wide range of other site characteristics, such as logins, viewing activity (also filtered by topic if desired)

### Detailed Task-Level Description

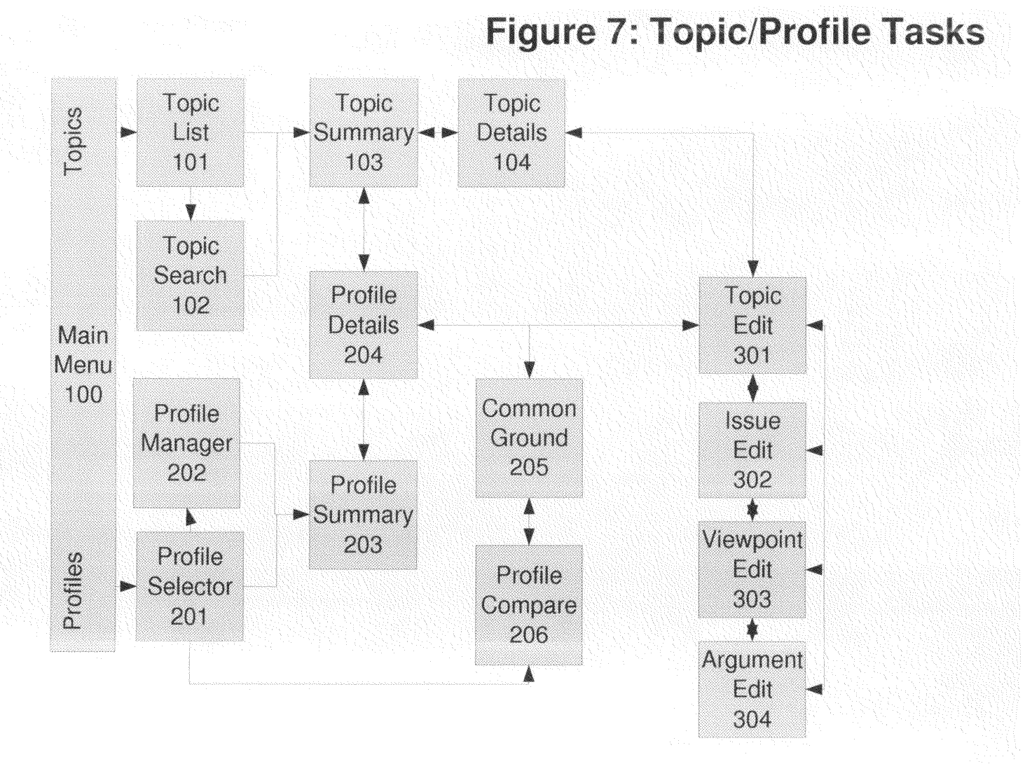

Using Topics (references to tasks shown in FIG. 7)

The user first selects a topic (say, abortion) by clicking on “Topics” from the MainMenu (100). Then the user either selects a topic from the list (101), or after clicking on the topic search (102) and entering a keyword(s), selects one of the resulting topic links. Selecting a topic brings up the TopicSummary task (103). Two main choices are presented: (1) to view the questions associated with the user's topic, or (2) to answer the questions. The user can also click on a button to see a list of profiles that reference viewpoints relating to this topic.

The view option displays the TopicDetails task (104), allowing the user to navigate around in the contents hierarchy for that topic. The top level content for a topic is comprised of the questions, which TopicCentral refers to as issues. Each issue/question has two or more answers, dubbed viewpoints. Finally, each answer/viewpoint may be a number of supporting arguments. The user can freely expand and contract the hierarchical display as desired.

The other option on the TopicSummary task (103) permits the user to select the user's own set of preferred answers to the questions (issues). Choosing this option prompts the user to select a profile (to be used to store the user's answers). The user can either use one of the existing profiles, or create a new one.

Once the profile is selected, the user is presented with the ProfileDetails task (204) for that combination of topic and profile. Here too, the user is able to navigate the topic's hierarchical content. But this time, under each issue, one of the alternative viewpoints is highlighted. If the profile that the user selected was a new one, all the issues will have the ‘no position’ viewpoint highlighted. The user can click on other viewpoints to select them instead. The user can then save that user's choices.

If the user had selected an existing profile (instead of a new one) and that profile had been initialized against this same topic earlier, the previous selections of viewpoints would be highlighted. The user can then change any of them they may desire, and save the changes.

After saving the changes, the user is presented with the initial ProfileDetail task (204) again. The user is free to go back over the selections made and refine them as desired. The user can also click on “common ground” link to see how the selections compare with other major points of view on that topic, or click to return to the TopicSummary task (103).

If the user selects the “common ground” option, the user is presented with the CommonGround task (205), showing a list of profiles in descending order of their similarity to that user's own views. The common ground percentage reflects the number of that user's preferred viewpoints that are also present in the associated profile, as a proportion of the total viewpoints the user has selected. Some of the listed profiles will have a common ground of 0%, which means that, while these profiles hold perspectives on the same topic, none of those perspectives match that of the current user.

With a single click the user can view a side-by-side comparison between that user's answer set and those of the selected perspective profile. Afterwards, the user can click to return to that profile's details (which the user can continue to change, if desired).

From TopicCentral's main menu, the user can select another topic and repeat the above actions.

Using and Managing Perspective Profiles (references to tasks shown in FIG. 7)

For a profile that contains viewpoints on more than a single topic, the user can click on “Options” from the MainMenu (100), to be presented with the ProfileSelector task (201), showing a list of available topics. This list will include all of the user's own profiles, as well as others' profiles that have been made public by their owners.

Clicking on the desired profile will bring up the ProfileSummary task (203), which will display a list of topics covered by the selected profile. For each listed topic, the user has two options: (1) view the details of the selected profile with that topic (displaying the ProfileDetails task, mentioned earlier), or (2) view the “common ground” rankings of other profiles that also reference viewpoints relating to that topic (displaying the CommonGround task, mentioned above).

For owned profiles, the user may modify them by selecting the “Perspectives” item from the MainMenu (100), which displays the ProfileSelector task (201) and then selecting the “Profile Manager” option. The ProfileManager task (202) displays the list of all the profiles owned by the user. For any owned profile, the user may rename the profile (still under the requirement that the profile name be unique), or delete it. The user may also import the viewpoints from another available profile into their own profile. Finally, this page gives the user another opportunity to create new profiles.

### Editing Topic-Related Content (References to Tasks Shown in FIG. 7)

From either the TopicDetails task (104) or the ProfileDetails task (204), the user can click on the “Edit” option to display the top level Topic Edit task (301). On this page the user can (1) create new issues, (2) change the category-issue assignments, (3) expand/contract some or all of the issue categories, and (4) navigate through the topic's components via the “Issue” links.

Clicking on an “Issue” link brings up the associated IssueEdit task (302). At this level, the item referred to below is an ‘issue’ and the child item is a ‘viewpoint.’

From this page, the user can (1) create new child item, (2) edit the text associated the item, (3) view item version history and revert to an earlier version, (4) comment on the item (sent to the most recent author), (5) discuss the item (sent to a forum for that issue), (6) challenge the issue (which initiates a process for possibly removing the item), (7) navigate to a child item, and (8) navigate to the parent item.

Whenever an item is changed, the children items are automatically marked with a flag indicting that the parent item has been changed, and requesting a user to confirm that the changes to the parent have not changed the meaning of the child items.

Clicking on any of the viewpoint links brings up the ViewpointEdit task (303). At this level, the item referred to below is a ‘viewpoint’ and the child item is an ‘argument’.

From this page, the user can (1) create new child item, (2) edit the text associated the item, (3) view item version history and revert to an earlier version, (4) comment on the item (sent to the most recent author), (5) discuss the item (sent to a forum for that issue), (6) challenge the issue (which initiates a process for possibly removing the item), (7) navigate to a child item, and (8) navigate to the parent item.

Clicking on any of the argument links brings up the ArgumentEdit task (304). At this level, the item referred to below is an ‘argument’.

From this page, the user can (1) edit the text associated the item, (2) view item version history and revert to an earlier version, (3) comment on the item (sent to the most recent author), (4) discuss the item (sent to a forum for that issue), (5) challenge the issue (which initiates a process for possibly removing the item), and (7) navigate to the parent item.

While the preferred implementation uses Java Server Page (JSP) technology, it is understood that the invention could be implemented with any computer language. While the preferred implementation uses a relational database to hold and manage the topic-related and perspective profile objects, it is understood that the invention could be implemented using a wide variety of other persistence strategies, including object database and individual files. While the preferred implementation uses a name field to store information about the object type, it is understood that the invention could be implemented using a wide range of other approaches to maintaining this kind of metadata. While the preferred implementation has the topic objects immutable (for ordinary users), it is understood that the invention could be implemented without this constraint.

The content related to topics is structured in a hierarchy with these characteristics:
the top level is the topic, which is a category that serves as a collecting point for similar issues
the second level is the issue, which is a description of a specific controversy related to the parent topic; in the preferred implementation, the issue is expressed as a question
the third level is the viewpoint, which is an alternative outcome of the parent controversy; in the preferred implementation, the viewpoint is expressed as an answer to the question posed in the parent issue
the fourth level is the argument, which is an expression of rationale that supports the parent viewpoint; in the preferred implementation, the argument will typically be between one and several sentences in length.

It is understood that different implementations of the invention may define different sets of user rights. In the preferred implementation, basic users may create as many personal profiles as they wish. Advanced users can also create concept, group, policy and public figure profiles.

The user's profiles are created, by default, to be private. Using the Profile Manager page, as discussed above, the user can toggle any profile so it is visible to others. That is, it will show up in the Profile Selector list as well as in related lists of profiles as appropriate.

If the user wishes to share views with specific other users, the user can change the profile's name to an innocuous code. Even when fully public, the profile with such a coded name will not be able to be associated with any particular user. The user would then notify those whom the user wanted to have access to the profile, and give them the coded name.

If the user wanted only to share views on a particular topic, the user could create the profile specifically covering only viewpoints on a particular topic.

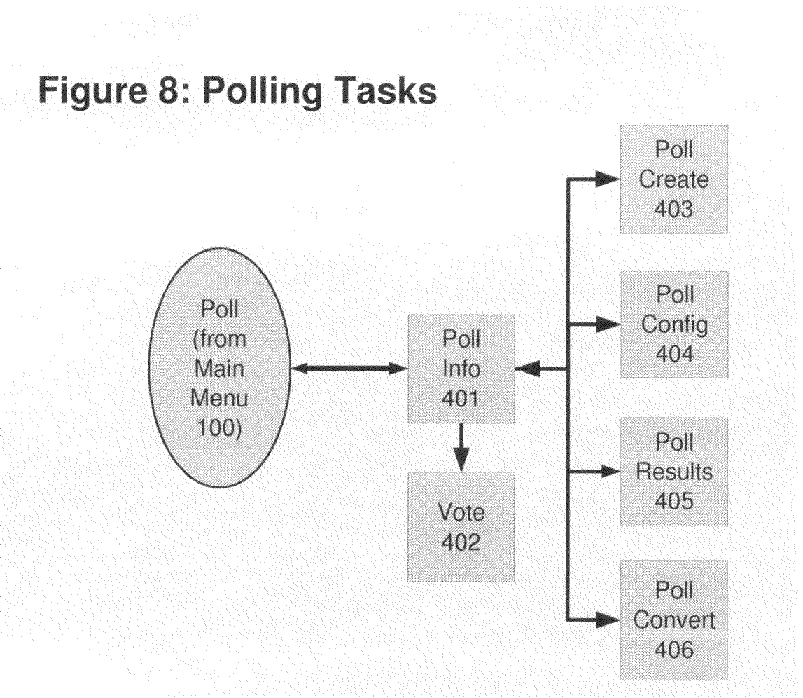

### Polling Activities (References to Tasks Shown in FIG. 8)

An administrator (or another designated individual) selects the “Poll” option from the Main Menu (100), to bring up the Poll Info task (401) and then selects the option which brings up the Poll Create task (403). The user selects the name of the user to be designated as the sponsor of the new poll, and adds any restrictions (such as the maximum number of participants, and/or the earliest and latest dates to conduct the poll). Then, when the ‘create’ option is selected, the user is presented with a unique poll code.

The person designated as the poll's sponsor brings up the Poll Config task (404), and enters the poll code. The system verifies that the current user is the designated sponsor, and that the poll code is valid and within the specified date parameters. The sponsor then optionally enters a description for the poll, the specific date/times that the poll will start and end, any notification options desired, and clicks “activate” to make the poll active.

Those individuals who have been provided with the poll code will activate the Poll Vote task (402), enter the poll code which the system will then validate. If the validation fails, the user will be informed about the reason for the failure. Otherwise the user is presented with a control allowing the user to select from among that user's perspective profiles, and then click the ‘vote’ option. At that point the viewpoints in the designated perspective profile will be aggregated with the viewpoints contained in any previous voters' selections.

The person designated as the poll's sponsor at any time can bring up the Poll Results task (405) to display the status of the poll, and the results as of that point in time. The sponsor may have optionally elected to allow poll participants the right to view the results as well.

The poll's sponsor may optionally convert the results of the poll into an perspective profile by bringing up the Poll Convert task (406). This option creates a new perspective profile, with a name provided by the sponsor and owned by the sponsor whose selected viewpoints represent the composite suggested by the poll results.

This polling capability provides a way for TopicCentral to earn revenue not only without interfering with, but with actively supporting, its primary mission. The organization conducting the poll will likely find the results not only unique and valuable, but cost-effective as well. There could be a charge for a poll, which was based on the number of topics as well as the number of participants. For example, a poll of 100 participants on a single topic might have one fee, with another applied to a poll of 500 participants on three separate topics. Or, there could be bundles of polls, where a single poll costs x while 5 polls cost 3×, or something similar.

The sponsor might be an advocacy group, or a political party. The sponsor may have a separate mailing list of people that support it or that it's interested in. They could use that vehicle for contacting them, providing the invite and polling codes and exhorting them to participate.

A poll sponsor arranges to get (a) an invite code, and (b) a polling code. The sponsor then contacts a group of people and gives them the invite code, requesting those who don't have a TopicCentral account to use it to establish one. At that time, or later, the sponsor contacts the group and asks them to review the TopicCentral content pertaining to some topic of interest, to ensure that it is complete. Optionally, the sponsor can encourage the group to make sure that appealing issues are included along with the strongest supporting arguments for the favored viewpoints on those issues, and to see to it that the issues most revealing of the opposition are present as well, in addition to checking to ensure that the opposition's arguments are factually sound.

Then, the sponsor passes the polling code to the group, indicating a desire to get a snapshot of the group's views on some topic of interest. The sponsor will ask the members to submit their views sometime between two dates.

The group members will then log into TopicCentral, and select the polling option, entering the polling code and indicating which private perspective profile they wish to use. That profile will then be displayed along with the option to modify it. Then, when each user is satisfied with the profile, they click the submit button.

Internally, TopicCentral will verify the poll code and ensure that the polling time is in the specified time interval, and will then add the selections in each user's profile to an polling perspective profile.

TopicCentral could provide the sponsor with an option to be notified whenever a participant submitted their views. This could be done via e-mail or via an RSS feed. Participants could agree to have their TopicCentral names included in the notification or have it done anonymously. The sponsor could have their name associated with the poll or not (though I'm not real sure how to do this meaningfully).

Once the poll is completed, the poll sponsor logs in and requests the aggregate. TopicCentral then tabulates all the totals and provides the polling perspective profile as a private profile to the sponsor. The sponsor may elect to make it available to all other group members; one way to do that is to rename it with a code, and then make that coded profile public. Then the sponsor will notify all the group members of the code. The sponsor may elect to user it internally, in which case the code could be provided only to selected individuals, perhaps on the sponsor's board of directors. The sponsor may also save the profile privately so another poll in the future can be compared with it.

The way it works is that when the first user of a poll submits a profile, TopicCentral will capture that profile into the initial form of the polling profile. As subsequent poll participants submit their profiles, TopicCentral will keep track of the number of times each viewpoint is referenced. In essence, it will simply add a count to each viewpoint reference (s_pos) and a count to the poll itself (perspective), along with the polling code. TopicCentral keeps track of the polling code, the valid intervals and the poll sponsor's id.

When the sponsor requests the poll profile, TopicCentral will cycle though all the issues, indicating for each viewpoint the percentage that selected that viewpoint. So the display of the polling profile will include a percentage for each viewpoint that at least one polled user selected.

The content on TopicCentral is built up with a ‘ratcheting’ mechanism. More issues are identified, more viewpoints are identified, and more arguments added. Each time a user makes a change, the changes are instantly made available to all users. Users' motivations for making the changes vary widely; but whatever their reasons, they all contribute. None of the TopicCentral information is particularly perishable, so remains fresh and relevant indefinitely. Behind the scenes, to minimize clutter, TopicCentral monitors overall activity and eventually prunes away content items for which there's little or not interest (by other than the items' creators).

1- A perspective evaluation system, comprising:
a) an issue content repository, comprising one or more topics, each topic comprising one or more issues, each issue comprising one or more viewpoints;
b) a perspectives content repository, comprising one or more perspective profiles, each perspective profile comprising a profile subject, a profile owner and zero or more viewpoint references, each reference comprising an identified viewpoint from the issue content repository;
c) an issue selector means providing functionality to users to obtain a list of all issues under a specified topic, and all viewpoints under a specified issue; and,
d) a profile selector means providing functionality to users to obtain a list of all profiles owned by a specified user, and all profiles containing references to viewpoints under a specified topic;
thereby providing users with unique insights about the points of view of the key players that influence contemporary controversies.

2- the system described in claim 1 further comprising an issue content editing means providing functionality to users to create new issues and viewpoints, and to edit existing issues and viewpoints, thereby providing a means for users to create much of the content, and do so in a way that helps ensure a wide diversity of interests and consequently a comprehensive set of issues.

3- the system described in claim 1 wherein each topic further comprising a topic category, each issue further comprising a question representing a controversy related to the parent topic, each viewpoint further comprising an answer to the parent issue's question, thereby providing a structure that minimizes conflict among users of differing outlooks.

4- the system described in claim 1 wherein each viewpoint further comprising zero or more arguments, each argument comprising a rationale supporting the parent viewpoint's answer, and wherein said issue selector means provides additional functionality to users to obtain a list of all arguments under a specified viewpoint, thereby allowing advocates of different points of view the capability to make the best arguments supporting that point of view.

5- the system described in claim 1 further comprising a profile content editing means providing functionality to users to create new perspective profiles and to edit perspective profiles created by the same user, thereby ensuring a degree of accountability not possible if multiple users edited the same profile.

6- the system described in claim 1 further comprising a profile comparison means providing functionality to users to compare perspective profiles side-by-side with each other, thereby providing unique and valuable insights into parallels among differing points of view.

7- the system described in claim 1 further comprising a profile similarity scoring means providing functionality to compute and associate a score with each perspective profile equaling the similarity between selected perspective profiles, thereby permitting users to easily understand where their personal beliefs place them on the spectrum of conventional points of view.

8- the system described in claim 1 further comprising an anti-cherry-picking means providing functionality to identify issues under a topic addressed by a specified perspective profile for which said profile has failed to include a viewpoint reference, and highlighting unreferenced but relevant issues, thereby providing a strong incentive for profile sponsors to be comprehensive in defining the scope of their profiles.

9- the system described in claim 1 wherein each perspective profile further comprising a topic type corresponding to different types of profile subjects, including individual users of said system, public figures, organizations, concepts/philosophies and policies, thereby providing the opportunity to compare the outlooks and impacts from entirely different entities.

10- the system described in claim 1 further comprising a challenge manager providing functionality to users to file a challenge to an issue or viewpoint and to a designated moderator to reject the challenge, accept the challenge and remove the challenged issue or viewpoint, or designate the challenged issue or viewpoint as “in dispute,” thereby providing an incentive for users to avoid unnecessary conflicts.

11- A method for organizing different points of view on issues, the method comprising:
a) collecting topic information comprising issues, viewpoints and arguments;
b) placing collected topic information into a repository, each said topic being linked to one or more relevant issues, each said issue being linked to one or more viewpoints, and each said viewpoint being linked to zero or more arguments;
c) creating a perspective profile for a said point of view, said profile comprising a subject, an owner and one or more viewpoint references;
d) creating new topic information and placing said new topic information into said repository;
e) assigning identities of selected said viewpoints in said repository to said perspective profile references;

12- the method described in claim 11 further comprising comparing said viewpoints associated with one said perspective profile with viewpoints associated with other said perspective profiles, and scoring said perspective profiles to indicate the degree of similarity between said profiles.
